(19) United States
(12) Patent Application Publication
(10) Pub. No.: US 2024/0258013 A1
(43) Pub. Date: Aug. 1, 2024

(54) COIL COMPONENT, CIRCUIT MODULE, ELECTRONIC DEVICE, AND METHOD OF MANUFACTURING COIL COMPONENT

(71) Applicant: Taiyo Yuden Co., Ltd., Tokyo (JP)

(72) Inventors: Tomoyuki Oyoshi, TOKYO (JP); Yoshiji Sekiguchi, TOKYO (JP); Takefumi Yamada, TOKYO (JP)

(21) Appl. No.: 18/419,971

(22) Filed: Jan. 23, 2024

(30) Foreign Application Priority Data
Jan. 30, 2023 (JP) 2023-012374

(51) Int. Cl. H01F 27/28; H01F 27/29; H01F 41/04; H01F 41/10

(52) U.S. Cl. CPC H01F 27/2804; H01F 27/292; H01F 41/041; H01F 41/10; H01F 2027/2809

(57) ABSTRACT

Provided is a coil component including a base body having a first surface and including an insulating material, the first surface having a first region, a second region, and a third region provided between the first region and the second region and rougher than the first region and the second region, a coil conductor provided in the base body, a first external electrode connected to one end of the coil conductor and provided on the base body in the first region, and a second external electrode connected to another end of the coil conductor and provided on the base body in the second region.

### CROSS REFERENCE TO RELATED APPLICATIONS

This application claims priority benefit of Japanese Patent Application No. JP 2023-012374 filed in the Japan Patent Office on Jan. 30, 2023. Each of the above-referenced applications is hereby incorporated herein by reference in its entirety.

### BACKGROUND

The present disclosure relates to a coil component, a circuit module including the coil component, and an electronic device including the circuit module. The present disclosure also relates to a method of manufacturing the coil component.

Coil components are passive elements used in electronic circuits. For example, coil components are used to eliminate noise in power supply lines and signal lines.

As electronic circuits become miniaturized, there is a demand for miniaturized coil components that can be mounted in such electronic circuits. A miniaturized coil component is disclosed in Japanese Patent Laid-open No. 2014-192487 (hereinafter referred to as Patent Document 1), for example.

### SUMMARY

Since miniaturized coil components are reduced in weight in proportion to the miniaturization, the miniaturized coil components easily adhere to other components due to static electricity. If a coil component adheres to another component, there is a possibility that handling of the coil component is hindered. For example, when the miniaturized coil component is mounted on a substrate, the coil component adheres to a gripping member (e.g., a nozzle, a collet, etc.) of a mounter, making it difficult to detach the coil component from the gripping member. The miniaturized coil component also easily adheres to a gripping member such as tweezers. Thus, if the coil component adheres to another component, mounting of the coil component on the substrate and transfer of the coil component to a test tray cannot be performed efficiently.

A coil component may be miniaturized by reducing the thickness of a portion of an external electrode that protrudes from a surface of a base body or by preventing the external electrode from protruding from the surface of the base body. For example, in the coil component described in Patent Document 1, external electrodes are embedded in a base body in such a manner as to be flush with a surface of the base body. With this configuration, the external electrodes do not protrude from the surface of the base body. If the thickness of the external electrodes is reduced to miniaturize the coil component, a gap between the coil component and another component is reduced. This makes the coil component more likely to adhere to the other component.

It is hence desirable to overcome or reduce at least part of the above drawback. Specifically, it is desirable to provide a coil component that is less likely to adhere to other components. Various technologies disclosed herein may collectively be referred to as the “present technology.”

Other achievements to be provided by the present technology will be made apparent through the entire description in the specification. The technology disclosed herein may also overcome drawbacks other than that recognized from the above description.

A coil component according to one or more embodiments of the present technology includes a base body, a coil conductor provided in the base body, a first external electrode connected to one end of the coil conductor, and a second external electrode connected to another end of the coil conductor. The base body includes an insulating material. A first surface of the base body has a first region, a second region, and a third region provided between the first region and the second region and rougher than the first region and the second region. A first external electrode is provided on the base body in the first region. A second external electrode is provided on the base body in the second region.

According to one or more embodiments of the present technology disclosed herein, a coil component that is less likely to adhere to other components can be provided.

### BRIEF DESCRIPTION OF THE DRAWINGS

FIG. 1 is a perspective view schematically illustrating a coil component according to one embodiment of the present technology;

FIG. 2 is a cross-sectional view schematically illustrating a cross-section of the coil component illustrated in FIG. 1 and cut along line I-I;

FIG. 3 is a bottom view of the coil component illustrated in FIG. 1;

FIG. 4 is a cross-sectional view schematically illustrating a cross-section of the coil component according to another embodiment of the present technology;

FIG. 5 is a cross-sectional view schematically illustrating a cross-section of the coil component according to another embodiment of the present technology;

FIG. 6 is a cross-sectional view schematically illustrating a cross-section of the coil component according to another embodiment of the present technology;

FIG. 7 is a cross-sectional view schematically illustrating a cross-section of the coil component according to another embodiment of the present technology;

FIG. 8 is a bottom view of the coil component illustrated in FIG. 7;

FIG. 9 is an enlarged cross-sectional view illustrating part of the cross-section of the coil component illustrated in FIG. 7 on an enlarged scale;

FIG. 10 is a cross-sectional view schematically illustrating a cross-section of a coil component according to another embodiment of the present technology;

FIG. 11 is a top view of the coil component illustrated in FIG. 10;

FIG. 12 is a cross-sectional view schematically illustrating a cross-section of the coil component according to another embodiment of the present technology;

FIG. 13 is a flowchart illustrating a method of manufacturing the coil component according to one embodiment of the present technology;

FIG. 14 is a flowchart illustrating a method of manufacturing the coil component according to one embodiment of the present technology;

FIG. 15 is a flowchart illustrating a method of manufacturing the coil component according to one embodiment of the present technology; and

FIG. 16 is a view schematically illustrating a lower surface of a molded body fabricated by the manufacturing method illustrated in FIG. 15.

### DETAILED DESCRIPTION OF THE PREFERRED EMBODIMENTS

Various embodiments of the present technology will be described below with reference to the accompanying drawings as appropriate. Throughout the drawings, the constituent elements common in the drawings are denoted by the same or similar reference signs. For convenience of explanation, the drawings are not necessarily drawn to scale. The following embodiments do not necessarily limit the scope of the claims. The elements included in the following embodiments are not necessarily essential to solve the drawbacks addressed by the technology.

### 1. First Embodiment

### 1-1. Basic Structure of Magnetically Coupled Coil Component

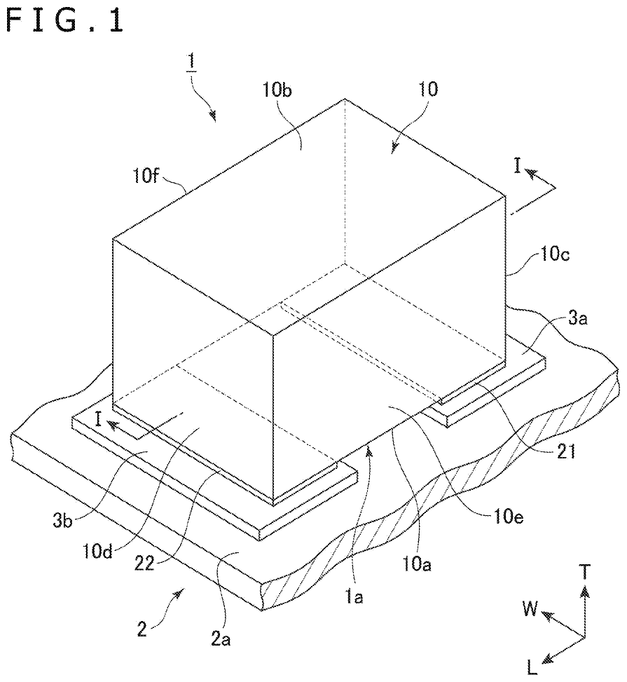

A basic structure of a coil component 1 according to a first embodiment will be described below with reference to FIG. 1. FIG. 1 is a perspective view of the coil component 1 according to the first embodiment.

The coil component 1 may be an inductor, a transformer, a filter, a reactor, an inductor array, or any one of various other coil components. The coil component 1 may alternatively be a coupled inductor, a choke coil, or any one of various other magnetically coupled coil components. The coil component 1 may be, for example, an inductor used in a direct current to direct current (DC/DC) converter. Applications of the coil component 1 are not limited to those explicitly described herein.

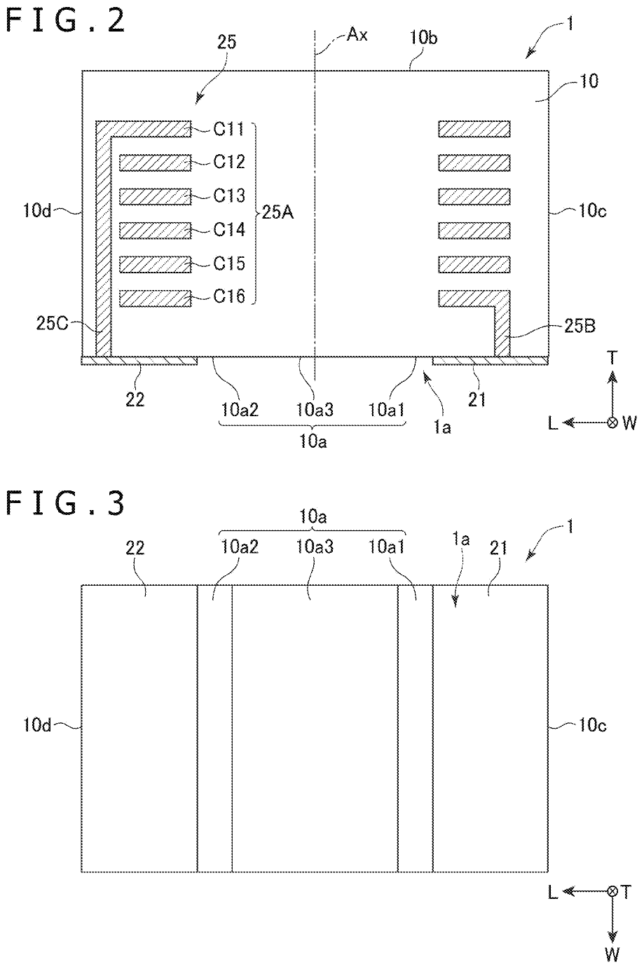

The coil component 1 includes an insulating base body 10, a coil conductor 25 (see FIG. 2), which is provided in the base body 10, a first external electrode 21, and a second external electrode 22.

The coil component 1 may be mounted on a mounting substrate 2a. The mounting substrate 2a includes land portions 3a and 3b. The coil component 1 is mounted on the mounting substrate 2a by connecting the first external electrode 21 to the land portion 3a and connecting the second external electrode 22 to the land portion 3b. The coil component 1 is mounted on the mounting substrate 2a such that a mounting surface 1a faces the mounting substrate 2a. The mounting surface 1a refers to an outer surface on which the first external electrode 21 and the second external electrode 22 are provided and which is among outer surfaces of the coil component 1.

A circuit board 2 according to one embodiment of the present technology includes the coil component 1 and the mounting substrate 2a on which the coil component 1 is mounted. The circuit board 2 can be installed in various electronic devices. The electronic devices in which the circuit board 2 can be installed include smartphones, tablets, game consoles, electrical components of automobiles, servers, and various other electronic devices.

### 1-2. Basic Structure of Base Body 10

In one mode, the base body 10 includes an insulating material and has a rectangular parallelepiped shape. For example, the dimension (length dimension) of the coil component 1 in an L-axis direction is in a range of 0.2 to 2.0 mm, the dimension (width dimension) of the coil component 1 in a W-axis direction is in the range of 0.2 to 2.0 mm, and the dimension (height dimension) of the coil component 1 in a T-axis direction is in the range of 0.2 to 2.0 mm. In one mode, the length dimension of the coil component 1 may be greater than the width dimension of the coil component 1. The term “rectangular parallelepiped” or “rectangular parallelepiped shape” described herein is not intended to solely mean “rectangular parallelepiped” in a mathematically strict sense. As described below, the corners and/or edges of the base body 10 may be curved. The dimensions and the shape of the base body 10 are not limited to those explicitly described herein.

The base body 10 has a first principal surface 10a, a second principal surface 10b, a first end surface 10c, a second end surface 10d, a first side surface 10e, and a second side surface 10f. The first end surface 10c, the second end surface 10d, the first side surface 10e, and the second side surface 10f are all connected to the first principal surface 10a and the second principal surface 10b. The first end surface 10c also connects the first side surface 10e and the second side surface 10f to each other. The second end surface 10d also connects the first side surface 10e and the second side surface 10f to each other. The first principal surface 10a and the second principal surface 10b are at opposite ends in a height direction of the base body 10. The first end surface 10c and the second end surface 10d are at opposite ends in a length direction of the base body 10. The first side surface 10e and the second side surface 10f are at opposite ends in a width direction of the base body 10. As illustrated in FIG. 1, the first principal surface 10a is on a lower side of the base body 10, and hence, the first principal surface 10a may be referred to as a “lower surface.” Similarly, the second principal surface 10b may be referred to as an “upper surface.” The first principal surface 10a is an example of a “first surface” in the claims. Accordingly, the first principal surface 10a may be referred to as a “first surface 10a.” The second principal surface 10b is an example of a “second surface” in the claims. Hence, the second principal surface 10b may be referred to as a “second surface 10b.”

In the illustrated embodiment, the first external electrode 21 and the second external electrode 22 are provided on the first surface 10a of the base body 10. In the illustrated embodiment, both the first external electrode 21 and the second external electrode 22 are in contact with the base body 10 only on the first surface 10a of the base body 10 and are not in contact with any of the surfaces of the base body 10 other than the first surface 10a. In other words, both the first external electrode 21 and the second external electrode 22 are separated from the second surface 10b, the first end surface 10c, the second end surface 10d, the first side surface 10e, and the second side surface 10f. One of or both the first external electrode 21 and the second external electrode 22 may extend to a surface of the base body 10 other than the first surface 10a. For example, the first external electrode 21 may extend in such a manner as to come into contact with not only the first surface 10a but also the first end surface 10c. The second external electrode 22 may extend in such a manner as to come into contact with not only the first surface 10a but also the second end surface 10d. Further, the first external electrode 21 may extend in such a manner as to come into contact with not only the first surface 10a but also the first end surface 10c, while the second external electrode 22 may extend in such a manner as to come into contact with not only the first surface 10a but also the second end surface 10d. When the first external electrode 21 extends to a surface of the base body 10 beyond the first surface 10a, the area of contact between the first external electrode 21 and the first surface 10a may be greater than the area of contact between the first external electrode 21 and the surface other than the first surface 10a. For example, when the first external electrode 21 extends in such a manner as to come into contact with not only the first surface 10a but also the first end surface 10c, the area of contact between the first external electrode 21 and the first surface 10a may be greater than the area of contact between the first external electrode 21 and the first end surface 10c. Similarly, when the second external electrode 22 extends to a surface of the base body 10 beyond the first surface 10a, the area of contact between the second external electrode 22 and the first surface 10a may be greater than the area of contact between the second external electrode 22 and the surface other than the first surface 10a. For example, when the second external electrode 22 extends in such a manner as to come into contact with not only the first surface 10a but also the second end surface 10d, the area of contact between the second external electrode 22 and the first surface 10a may be greater than the area of contact between the second external electrode 22 and the second end surface 10d.

The first surface 10a and the second surface 10b are separated by a distance equal to the height of the base body 10. The first end surface 10c and the second end surface 10d are separated by a distance equal to the length of the base body 10. The first side surface 10e and the second side surface 10f are separated by a distance equal to the width of the base body 10. In this specification, unless the context otherwise requires, the “length” direction, the “width” direction, and the “thickness” direction of the coil component 1 refer to the L-axis direction, the W-axis direction, and the T-axis direction of FIG. 1, respectively.

The base body 10 includes an insulating material with excellent insulation properties. The base body 10 may 10 may include a magnetic material. The magnetic material used for the base body 10 may be a soft magnetic alloy material, a composite magnetic material containing magnetic particles dispersed in resin, a ferrite material, or any other known magnetic materials.

The base body 10 may include a magnetic material. The base body 10 may contain a plurality of metal magnetic particles bonded to each other. In the base body 10, the metal magnetic particles may be bonded to each other by an oxide film formed by oxidation of an element contained in the metal magnetic particles during a manufacturing process. The base body 10 may contain a binder in addition to the metal magnetic particles. When the base body 10 contains a binder, the metal magnetic particles are bonded to each other by the binder.

### 1-3. Basic Structure of Coil Conductor

The coil conductor 25, which is provided inside the base body 10, will be described below with reference to FIG. 2. FIG. 2 illustrates a cross-section of the coil component 1 cut in a plane which is parallel to an LT plane and which passes through a coil axis Ax.

As illustrated in FIG. 2, the coil conductor 25 includes a winding portion 25A, which is wound around the coil axis Ax extending along the thickness direction (T-axis direction), a lead-out portion 25B, which extends from one end of the winding portion 25A to the first surface 10a of the base body 10, and a lead-out portion 25C, which extends from the other end of the winding portion 25A to the first surface 10a of the base body 10. As illustrated in FIG. 2, the coil conductor 25 is provided such that only an end surface of the lead-out portion 25B and an end surface of the lead-out portion 25C are exposed from the base body 10. The portions other than the end surfaces of the coil conductor 25 are embedded in the base body 10.

The winding portion 25A includes a plurality of conductor patterns C11 to C16. The plurality of conductor patterns C11 to C16 extend in the direction of a plane perpendicular to the coil axis Ax and are spaced apart from each other in the direction of the coil axis Ax. Each of the conductor patterns C11 to C16 is electrically connected to an adjacent conductor pattern through an unillustrated via. In this way, the winding portion 25A of the coil conductor 25 includes the conductor patterns C11 to C16 and vias. The conductor pattern C11 is electrically connected to the second external electrode 22 via the lead-out portion 25C, and the conductor pattern C16 is electrically connected to the first external electrode 21 via the lead-out portion 25B.

In one embodiment, each of the first external electrode 21 and the second external electrode 22 may include a plating layer formed on the first surface 10a of the base body 10 by electrolytic plating or electroless plating. Each of the first external electrode 21 and the second external electrode 22 may include two or more plating layers. For example, each of the first external electrode 21 and the second external electrode 22 may include an Ni plating layer formed on the first surface 10a of the base body 10 and an Sn plating layer formed on a surface of the Ni plating layer. The plating layer included in the first external electrode 21 may be directly connected to the end surface of the lead-out portion 25B or may be connected thereto via a base electrode layer included in the first external electrode 21. Similarly, the plating layer included in the second external electrode 22 may be directly connected to the end surface of the lead-out portion 25C or connected thereto via a base electrode layer included in the second external electrode 22.

### 1-4. Configuration of First Surface 10a of Base Body 10

A configuration of the first surface 10a of the base body 10 will be further described below with reference to FIG. 3.

In one mode, the first surface 10a of the base body 10 is divided into a first region 10a1, a second region 10a2, and a third region 10a3. Each of the first region 10a1, the second region 10a2, and the third region 10a3 extends along the L-axis direction and the W-axis direction. In the illustrated embodiment, each of the first region 10a1, the second region 10a2, and the third region 10a3 extends along the W-axis direction from one end of the first surface 10a in the W-axis direction to the other end.

In the illustrated embodiment, the third region 10a3 is located between the first region 10a1 and the second region 10a2 in the L-axis direction. The first region 10a1 is located on a negative side in the L-axis direction with respect to the third region 10a3 in the L-axis direction. The first region 10a1 extends from one end of the third region 10a3 to the first end surface 10c of the base body 10 in the L-axis direction. The second region 10a2 is located on a positive side in the L-axis direction with respect to the third region 10a3 in the L-axis direction. The second region 10a2 extends from the other end of the third region 10a3 to the second end surface 10d of the base body 10 in the L-axis direction.

In the illustrated embodiment, part of the first region 10a1 is covered with the first external electrode 21. Alternatively, the entire first region 10a1 may be covered with the first external electrode 21. Similarly, part of the second region 10a2 is covered with the second external electrode 22. Alternatively, the entire second region 10a2 may be covered with the second external electrode 22.

As clearly illustrated in FIG. 3, part of the first region 10a1 may be interposed between the first external electrode 21 and the third region 10a3. Similarly, part of the second region 10a2 may be interposed between the second external electrode 22 and the third region 10a3. In the illustrated embodiment, a strip-shaped portion of the first region 10a1 extending along the W-axis direction is interposed between the first external electrode 21 and the third region 10a3, and a strip-shaped portion of the second region 10a2 extending along the W-axis direction is interposed between the second external electrode 22 and the third region 10a3.

In one mode of the present technology, the third region 10a3 is rougher than the first region 10a1 and the second region 10a2. In this specification, the surface roughness of the base body 10 is represented by arithmetic surface roughness Sa of the surface of the base body 10. The arithmetic surface roughness Sa is calculated by a measuring instrument conforming to ISO 25178. For example, the arithmetic surface roughness Sa can be measured using a shape analysis laser microscope (VK-X250) manufactured by Keyence Corporation. When the arithmetic surface roughness of the first region 10a1 is Sa1, the arithmetic surface roughness of the second region 10a2 is Sa2, and the arithmetic surface roughness of the third region 10a3 is Sa3, Sa3 is greater than Sa1 and Sa2. In one mode, Sa3 is two or more times greater than Sa1 and Sa2. In one mode, Sa3 may be between two and five times greater than Sa1 and Sa2. Sa1 and Sa2 may be of a similar degree. Sa1 may be between 0.8 and 1.2 times greater than Sa2. Sa1 and Sa2 may be in the range of 0.1 to 3.0 μm. Sa3 may be greater than Sa1 and Sa2, specifically in the range of 2.0 to 5.0 μm. The roughness of each of the first region 10a1, the second region 10a2, and the third region 10a3 may be represented by arithmetic mean roughness Ra instead of the arithmetic surface roughness Sa. The arithmetic mean roughness Ra may be measured along the direction of the lines obtained by tracing the regions.

The third region 10a3 may be formed by roughening the first surface 10a during the manufacturing process of the base body 10. A partial region of the uniformly roughened surface of the base body 10 is roughened, so that the roughened region can be used as the third region 10a3. The first surface 10a may be roughened by sandblasting, laser irradiation, or any other known roughening methods.

When the base body 10 contains metal magnetic particles, the surface of the base body 10 has the roughness corresponding to the particle size of the metal magnetic particles. The surface of a portion containing metal magnetic particles of a relatively large diameter is rougher than the surface of a portion containing metal magnetic particles of a relatively small diameter. In one mode of the present technology, a portion of the base body 10 having the third region 10a3 contains first metal magnetic particles of a relatively large diameter, and the other portions of the base body 10 contain second metal magnetic particles of a smaller diameter than that of the first metal magnetic particles. Accordingly, the third region 10a3 is rougher than the first region 10a1 and the second region 10a2 since the third region 10a3 corresponds to the surface of the portion containing the first metal magnetic particles of a larger diameter than that of the second metal magnetic particles. In one mode, the average particle diameter of the first metal magnetic particles is equal to or greater than two times the average particle diameter of the second metal magnetic particles.

In the illustrated embodiment, the first surface 10a has only the first region 10a1, the second region 10a2, and the third region 10a3. However, the first surface 10a may have a region other than the first region 10a1, the second region 10a2, and the third region 10a3. When the first surface 10a has an additional region other than the first region 10a1, the second region 10a2, and the third region 10a3, the third region 10a3 is rougher than the additional region.

In one mode of the present technology, the third region 10a3, which is part of the first surface 10a constituting the mounting surface 1a of the coil component 1, is rougher than the other regions (e.g., the first region 10a1 and the second region 10a2) of the first surface 10a. This configuration can weaken the electrostatic force that acts between the third region 10a3 and another component (such as another electronic component or gripping member) when the coil component 1 is charged. In this way, since the first surface 10a of the base body 10 has the third region 10a3 rougher than the other regions, the electrostatic force between the third region 10a3 and another component is weakened, making it less likely for the coil component 1 to adhere to the other component.

Part of the mounting surface 1a of the coil component 1 is defined by the conductive first and second external electrodes 21 and 22, and the rest of the mounting surface 1a is defined by the first surface 10a of the insulating base body 10. Hence, on the mounting surface 1a of the coil component 1, the work functions of the conductive first and second external electrodes 21 and 22 are different from the work function of the insulating base body 10, so that, when the coil component 1 comes into contact with another component, only the mounting surface 1a of the coil component 1 may be charged or the mounting surface 1a may be charged more than the other surfaces of the coil component 1. Thus, in the coil component 1, a large electrostatic force may act between the mounting surface 1a and the other component compared to the surfaces other than the mounting surface 1a. In other words, the charging of the mounting surface 1a may become the main cause of adhesion between the coil component 1 and the other component. In one mode of the present technology, the third region 10a3 of the first surface 10a of the base body 10, which occupies part of the mounting surface 1a of the coil component 1, is rougher than the other regions, so that the electrostatic force that acts on the mounting surface 1a of the coil component 1 can be weakened. This reduces undesired adhesion between the mounting surface 1a of the coil component 1 and another electronic component or gripping member.

Moreover, since the third region 10a3 of the first surface 10a of the base body 10, which occupies the part of the mounting surface 1a of the coil component 1, is rougher than the other regions, the effective contact area between the third region 10a3 and another component that comes into contact with the coil component 1 can be reduced. Accordingly, when the coil component 1 comes into contact with another component, the mounting surface 1a is less likely to be charged. In this case, since charging of the mounting surface 1a can be reduced, the electrostatic force that acts between the mounting surface 1a and the other component can be weakened.

### 2. Second Embodiment (Coil Component is Sealed by Resin Molding)

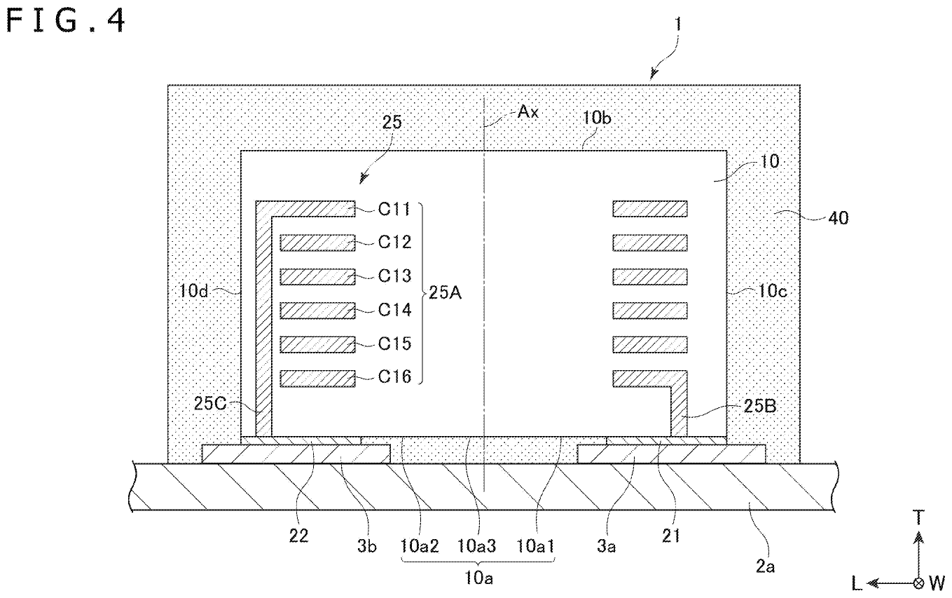

A second embodiment of the present technology will be described below with reference to FIG. 4. In the embodiment illustrated in FIG. 4, the coil component 1 mounted on the mounting substrate 2a is sealed by a resin molding 40. The resin molding 40 includes a resin material. The resin material used for the resin molding 40 is a resin material with excellent insulating, waterproof, and heat resistance properties. The resin material used for the resin molding 40 may be thermosetting resin or ultraviolet curing resin. The resin material used for the resin molding 40 is, for example, epoxy or polyimide. The material used for the resin molding 40 is not limited to those explicitly described herein. The resin molding 40 may include any other resin materials known as resin materials for resin moldings, as appropriate.

The resin molding 40 is provided on the mounting substrate 2a by a known method such as transfer molding. The resin molding 40 covers the coil component 1 and the mounting substrate 2a.

In one mode of the present technology, as described above, the strip-shaped portion of the first region 10a1 extending along the W-axis direction is interposed between the first external electrode 21 and the third region 10a3, and the strip-shaped portion of the second region 10a2 extending along the W-axis direction is interposed between the second external electrode 22 and the third region 10a3. The strip-shaped portions of the first region 10a1 and the second region 10a2 have a higher smoothness than that of the third region 10a3. Hence, during the formation of the resin molding 40, flowing resin easily flows into a gap between the coil component 1 and the mounting substrate 2a along the strip-shaped portions of the first region 10a1 and the second region 10a2 that are not covered by the first external electrode 21 and the second external electrode 22. As a result, the resin constituting the resin molding 40 spreads between the coil component 1 and the mounting substrate 2a, making it less likely for an air gap that may deteriorate the waterproof property to remain between the coil component 1 and the mounting substrate 2a. Thus, according to one mode of the present technology, the reliability of the mold sealing can be improved.

### 3. Third Embodiment (Mounting Surface 1a is Flat)

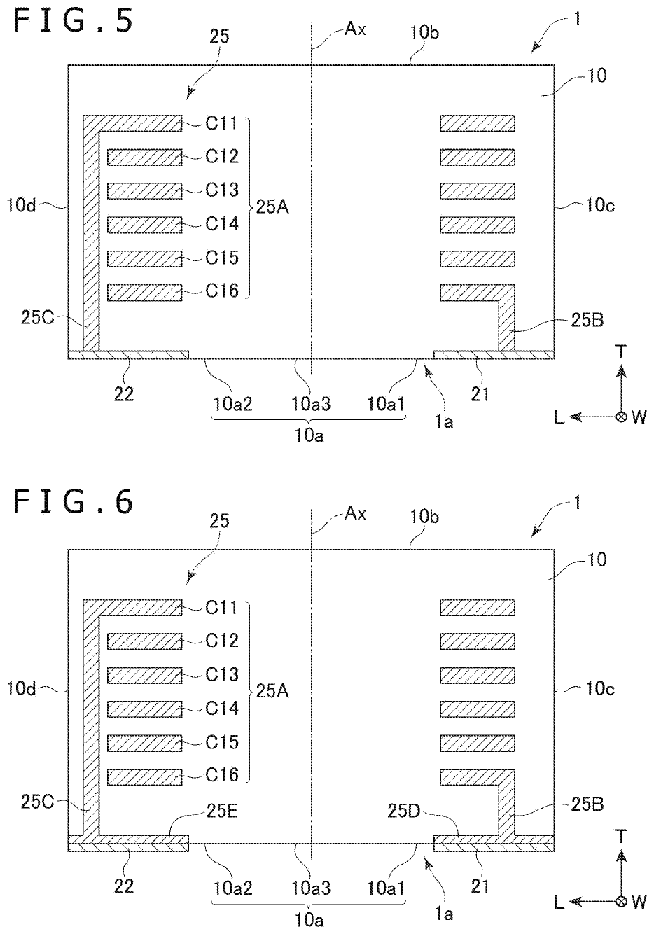

A third embodiment of the present technology will be described below with reference to FIG. 5. The embodiment illustrated in FIG. 5 is different from the first embodiment illustrated in FIG. 2 in the arrangement of the first external electrode 21 and the second external electrode 22. In the following description, the arrangement of the first external electrode 21 and the second external electrode 22 of the coil component 1 illustrated in FIG. 5 will mainly be described, and the features common to the first embodiment are not described.

FIG. 5 illustrates a cross-section of the coil component 1 according to the third embodiment that is cut in the plane which is parallel to the LT plane and which passes through the coil axis Ax. As illustrated in FIG. 5, the first external electrode 21 is provided such that a lower surface thereof is flush with the first surface 10a of the base body 10. Similarly, the second external electrode 22 is provided such that a lower surface thereof is flush with the first surface 10a of the base body 10.

According to the third embodiment, since the first external electrode 21 and the second external electrode 22 are provided such that their lower surfaces are flush with the first surface 10a of the base body 10, the first external electrode 21 and the second external electrode 22 do not protrude from the base body 10. This configuration can further miniaturize the coil component 1 in the T-axis direction. According to the third embodiment, moreover, since part of the first external electrode 21 and part of the second external electrode 22 are embedded in the base body 10, the first external electrode 21 and the second external electrode 22 can be firmly attached to the base body 10.

In the third embodiment, since the first external electrode 21 and the second external electrode 22 do not protrude from the base body 10, the mounting surface 1a of the coil component 1 is a flat surface without significant irregularities. Hence, the coil component 1 according to the third embodiment is more likely to adhere to another component, than the coil component 1 according to the first embodiment. However, since the third region 10a3 of the first surface 10a of the base body 10 is rougher than the other regions of the first surface 10a, the electrostatic force that acts between the third region 10a3 and another component is weakened even in the third embodiment. Therefore, in the third embodiment, the coil component 1 with the dimension thereof in the T-axis direction reduced is less likely to adhere to another component.

### 4. Fourth Embodiment (Coil Component Includes Internal Terminal Electrodes)

A fourth embodiment of the present technology will be described below with reference to FIG. 6. The embodiment illustrated in FIG. 6 is different from the first embodiment illustrated in FIG. 2 in that internal terminal electrodes connected to the external electrodes 21 and 22 are provided at the opposite ends of the coil conductor 25. In the following description, the arrangement of the first external electrode 21 and the second external electrode 22 of the coil component 1 illustrated in FIG. 6 will mainly be described, and the features common to the first embodiment are not described.

FIG. 6 illustrates a cross-section of the coil component 1 according to the fourth embodiment that is cut in the plane which is parallel to the LT plane and which passes through the coil axis Ax. As illustrated in FIG. 6, a first internal terminal electrode 25D is provided at one end of the coil conductor 25, and a second internal terminal electrode 25E is provided at the other end of the coil conductor 25.

In one mode, the first internal terminal electrode 25D has a cross-sectional area larger than that of the end surface of the lead-out portion 25B of the coil conductor 25. The cross-sectional area of the first internal terminal electrode 25D refers to the area of a cross-section of the first internal terminal electrode 25D cut along a WL plane. The cross-sectional area of the lead-out portion 25B refers to the area of a cross-section of the lead-out portion 25B cut along the WL plane. The coil conductor 25 is connected to the first external electrode 21 at the first internal terminal electrode 25D. The first internal terminal electrode 25D is partially embedded in the base body 10. The first internal terminal electrode 25D may be provided such that a lower surface thereof is flush with the first surface 10a of the base body 10. The first internal terminal electrode 25D may be partially exposed from the first end surface 10c of the base body 10.

In one mode, the second internal terminal electrode 25E has a cross-sectional area larger than that of the end surface of the lead-out portion 25C of the coil conductor 25. The cross-sectional area of the second internal terminal electrode 25E refers to the area of a cross-section of the second internal terminal electrode 25E cut along the WL plane. The cross-sectional area of the lead-out portion 25C refers to the area of a cross-section of the lead-out portion 25C cut along the WL plane. The coil conductor 25 is connected to the second external electrode 22 at the second internal terminal electrode 25E. The second internal terminal electrode 25E is partially embedded in the base body 10. The second internal terminal electrode 25E may be provided such that a lower surface thereof is flush with the first surface 10a of the base body 10. The second internal terminal electrode 25E may be partially exposed from the second end surface 10d of the base body 10.

The entire upper surface of the first external electrode 21 may be connected to the first internal terminal electrode 25D. The entire upper surface of the second external electrode 22 may be connected to the second internal terminal electrode 25E.

The first internal terminal electrode 25D and the second internal terminal electrode 25E may be formed by heating a conductive paste, as with the other portions of the coil conductor 25.

In the fourth embodiment, the first external electrode 21 is connected to the first internal terminal electrode 25D, which has a larger area than the lead-out portion 25B, so that the first external electrode 21 can be attached more firmly. Similarly, the second external electrode 22 is connected to the second internal terminal electrode 25E, which has a larger area than the lead-out portion 25C, so that the second external electrode 22 can be attached more firmly.

### 5. Fifth Embodiment (Coil Component Has First Recess)

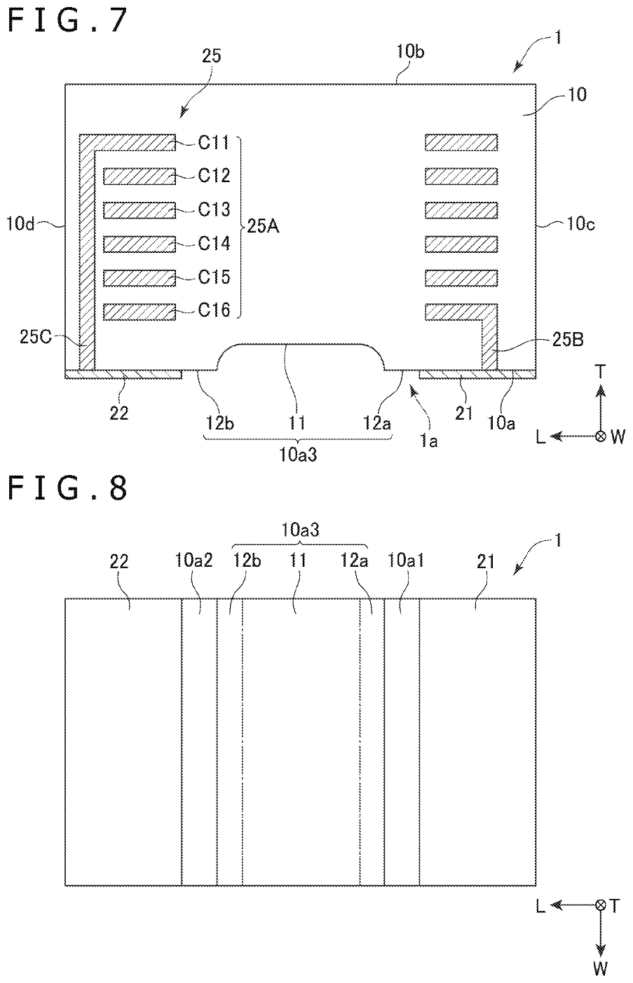

A fifth embodiment of the present technology will be described below with reference to FIGS. 7 to 9. The embodiment illustrated in FIGS. 7 to 9 is different from the first embodiment in that a recess (first recess 11) is formed on the first surface 10a of the base body 10. In the following description, the first recess 11 of the coil component 1 according to the fifth embodiment illustrated in FIGS. 7 to 9 will mainly be described, and the features common to the first embodiment are not described.

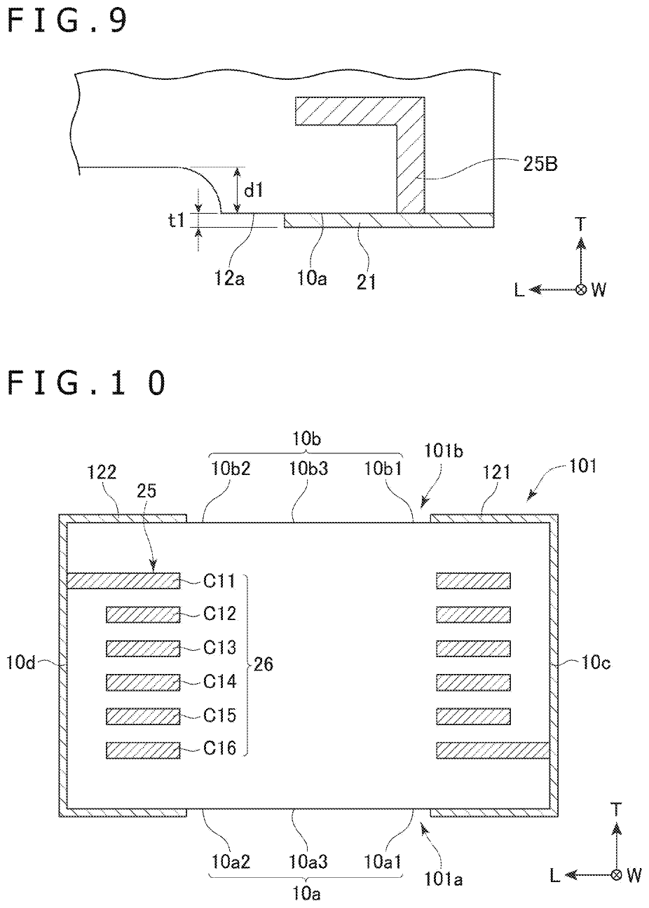

FIG. 7 illustrates a cross-section of the coil component 1 according to the fifth embodiment that is cut in the plane which is parallel to the LT plane and which passes through the coil axis Ax. FIG. 8 is a bottom view of the coil component 1 illustrated in FIG. 7. FIG. 9 is an enlarged cross-sectional view illustrating a region having part of the first recess 11 illustrated in FIG. 7 on an enlarged scale. As illustrated in FIGS. 7 to 9, in the fifth embodiment, the first surface 10a of the base body 10 has the first recess 11, which is recessed toward the inside of the base body 10.

In one mode of the present technology, the first recess 11 is formed on the third region 10a3 of the first surface 10a. More specifically, as clearly illustrated in FIG. 8, the third region 10a3 has a flat first reference surface 12a, which is connected to the first region 10a1, and a flat second reference surface 12b, which is connected to the second region 10a2. The first recess 11 is located between the first reference surface 12a and the second reference surface 12b in the L-axis direction. The first recess 11 is recessed from the first reference surface 12a and the second reference surface 12b toward the inside of the base body 10 (toward a positive side of the T-axis).

The first reference surface 12a is at the same position as the first region 10a1 in the T-axis direction and extends along the WL plane as with the first region 10a1. In other words, the first region 10a1 and the first reference surface 12a of the first surface 10a constitute a continuous flat surface. The second reference surface 12b is at the same position as the second region 10a2 in the T-axis direction and extends along the WL plane as with the second region 10a2. In other words, the second region 10a2 and the second reference surface 12b of the first surface 10a constitute a continuous flat surface. In FIG. 8, for convenience of explanation, line segments are drawn between the first reference surface 12a and the first region 10a1 and between the second reference surface 12b and the second region 10a2 to define them. In an actual coil component, however, there are no line segments that define the first reference surface 12a and the first region 10a1 and the second reference surface 12b and the second region 10a2 between them.

As illustrated in FIG. 9, the first recess 11 is recessed from the first reference surface 12a toward the T-axis direction by a depth d1. The depth d1 of the first recess 11 refers to the distance between the innermost portion of the first recess 11 inside the base body 10 and a plane passing through the first reference surface 12a.

According to the fifth embodiment, since the third region 10a3 is rougher than the other regions of the first surface 10a and the first recess 11 is provided on the third region 10a3, the area of contact between the mounting surface 1a of the coil component 1 and another component is reduced. Hence, undesired adhesion between the mounting surface 1a of the coil component 1 and another component can be further reduced. Moreover, the mounting surface 1a is far less likely to be charged when the coil component 1 comes into contact with another component.

As illustrated in FIG. 9, the first external electrode 21 has a thickness t1. The thickness t1 of the first external electrode 21 refers to the distance between the first reference surface 12a and the lower surface of the first external electrode 21. In one mode, the thickness t1 of the first external electrode 21 is smaller than the depth d1 of the first recess 11. The thickness t1 of the first external electrode 21 may be zero. In other words, the first external electrode 21 may be provided in such a manner as to be flush with the first surface 10a, as described in the third embodiment. Although not illustrated in FIG. 9, in one mode, the thickness of the second external electrode 22 is also smaller than the depth d1 of the first recess 11. The description of the thickness t1 of the first external electrode 21 also applies to the thickness of the second external electrode 22.

As described above, the thickness t1 of the first external electrode 21 and the thickness of the second external electrode 22 are small, so that the dimension of the coil component 1 in the T-axis direction can be reduced. Although the thickness t1 of the first external electrode 21 and the thickness of the second external electrode 22 are small and the mounting surface 1a of the coil component 1 is flat, the third region 10a3 is rougher than the other regions of the first surface 10a, and the first recess 11 is formed on the third region 10a3. Thus, the electrostatic force that acts between the mounting surface 1a and another component can be weakened. Accordingly, in the fifth embodiment, the coil component 1 with the dimension thereof in the T-axis direction reduced is less likely to adhere to another component.

### 6. Sixth Embodiment (External Electrodes Cover First Surface 10a and Second Surface 10b)

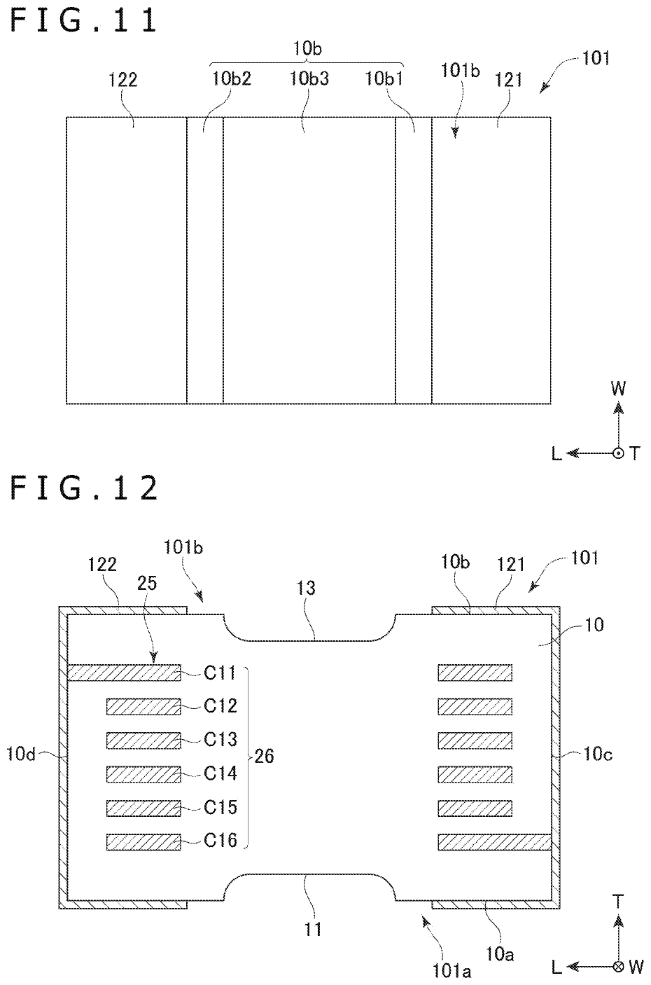

A coil component 101 according to a sixth embodiment of the present technology will be described below with reference to FIGS. 10 and 11. The coil component 101 is different from the coil component 1 in that the coil component 101 includes, instead of the first external electrode 21, a first external electrode 121, which is in contact with five surfaces of the base body 10, and, instead of the second external electrode 22, a second external electrode 122, which is in contact with five surfaces of the base body 10. The coil component 101 is different from the coil component 1 in that not only the first surface 10a of the base body 10 but also part of the second surface 10b is roughened. In the following description, the first external electrode 121 and the second external electrode 122 of the coil component 101 according to the sixth embodiment will mainly be described with reference to FIGS. 10 and 11, and the features common to the first embodiment are not described.

FIG. 10 illustrates a cross-section of the coil component 101 that is cut in the plane which is parallel to the LT plane and which passes through the coil axis Ax. FIG. 11 is a top view of the coil component 101 illustrated in FIG. 10.

In the coil component 101, the first external electrode 121 covers part of the first surface 10a, the first end surface 10c, and part of the second surface 10b. The first external electrode 121 may cover part of the first side surface 10e and/or part of the second side surface 10f. The second external electrode 122 covers part of the first surface 10a, the second end surface 10d, and part of the second surface 10b. The second external electrode 122 may cover part of the first side surface 10e and/or part of the second side surface 10f.

Since the first external electrode 121 and the second external electrode 122 cover the first surface 10a and the second surface 10b, the coil component 101 is mounted on the mounting substrate 2a such that a mounting surface 101a having the first surface 10a or a mounting surface 101b having the second surface 10b faces the mounting substrate 2a.

The mounting surface 101a of the coil component 101 is configured in a manner similar to that of the mounting surface 1a of the coil component 1 illustrated in FIG. 3. In other words, part of the mounting surface 101a of the coil component 101 is defined by the first external electrode 121 and the second external electrode 122, and the rest of the mounting surface 101a is defined by the first surface 10a of the base body 10. The first surface 10a has the first region 10a1, the second region 10a2, and the third region 10a3.

Part of the mounting surface 101b of the coil component 101 is defined by the first external electrode 121 and the second external electrode 122, and the rest of the mounting surface 101b is defined by the second surface 10b of the base body 10. In one mode, the second surface 10b of the base body 10 is divided into a fourth region 10b1, a fifth region 10b2, and a sixth region 10b3. Each of the fourth region 10b1, the fifth region 10b2, and the sixth region 10b3 extends along the L-axis direction and the W-axis direction. In the illustrated embodiment, each of the fourth region 10b1, the fifth region 10b2, and the sixth region 10b3 extends along the W-axis direction from one end of the second surface 10b in the W-axis direction to the other end.

In the illustrated embodiment, the sixth region 10b3 is located between the fourth region 10b1 and the fifth region 10b2 in the L-axis direction. The fourth region 10b1 is located on the negative side in the L-axis direction with respect to the sixth region 10b3 in the L-axis direction. The fourth region 10b1 extends from one end of the sixth region 10b3 to the first end surface 10c of the base body 10 in the L-axis direction. The fifth region 10b2 is located on the positive side in the L-axis direction with respect to the sixth region 10b3 in the L-axis direction. The fifth region 10b2 extends from the other end of the sixth region 10b3 to the second end surface 10d of the base body 10 in the L-axis direction.

In the illustrated embodiment, part of the fourth region 10b1 is covered by the first external electrode 121. Alternatively, the entire fourth region 10b1 may be covered by the first external electrode 121. Similarly, part of the fifth region 10b2 is covered by the second external electrode 122. Alternatively, the entire fifth region 10b2 may be covered by the second external electrode 122.

As clearly illustrated in FIG. 11, part of the fourth region 10b1 may be interposed between the first external electrode 121 and the sixth region 10b3. As understood from FIG. 11, a strip-shaped portion of the fourth region 10b1 extending along the W-axis direction is interposed between the first external electrode 121 and the sixth region 10b3. Further, a strip-shaped portion of the fifth region 10b2 extending along the W-axis direction is interposed between the second external electrode 122 and the sixth region 10b3.

In one mode of the present technology, the sixth region 10b3 is rougher than the fourth region 10b1 and the fifth region 10b2. In this specification, the surface roughness of the base body 10 is represented by the arithmetic surface roughness Sa of the surface of the base body 10. As described above, the arithmetic surface roughness Sa is calculated by a measuring instrument conforming to ISO 25178. When the arithmetic surface roughness of the fourth region 10b1 is Sa4, the arithmetic surface roughness of the fifth region 10b2 is Sa5, and the arithmetic surface roughness of the sixth region 10b3 is Sa6, Sa6 is greater than Sa4 and Sa5. In one mode, Sa6 is two or more times greater than Sa4 and Sa5. In one mode, Sa6 can be between two and five times greater than Sa4 and Sa5. Sa4 and Sa5 may be of a similar degree. Sa4 may be between 0.8 and 1.2 times greater than Sa5. Sa4 and Sa5 may be in the range of 0.1 to 3.0 μm. Sa6 may be greater than Sa4 and Sa5, specifically in the range of 2.0 to 5.0 μm. The roughness of each of the fourth region 10b1, the fifth region 10b2, and the sixth region 10b3 may be represented by the arithmetic mean roughness Ra instead of the arithmetic surface roughness Sa. The arithmetic mean roughness Ra may be measured along the direction of the lines obtained by tracing the regions.

The sixth region 10b3 may be formed by roughening the second surface 10b during the manufacturing process of the base body 10. A partial region of the uniformly roughened surface of the base body 10 is roughened, so that the roughened region can be used as the sixth region 10b3.

According to the embodiment described above, the third region 10a3 of the first surface 10a, which occupies part of the mounting surface 101a of the coil component 101, and the sixth region 10b3 of the second surface 10b, which occupies part of the mounting surface 101b, are rougher than the other regions of the base body 10, so that the electrostatic force that acts between the mounting surfaces 101a and 101b of the coil component 101 and another component can be weakened. Since the coil component 101 has the roughened regions (i.e., the third region 10a3 and the sixth region 10b3) on the two mounting surfaces 101a and 101b, undesired adhesion between the coil component 101 and another component can be further reduced.

### 7. Seventh Embodiment (Coil Component has Second Recess)

A seventh embodiment of the present technology will be described below with reference to FIG. 12. The embodiment illustrated in FIG. 12 is different from the sixth embodiment in that a recess (second recess 13) is formed on the second surface 10b of the base body 10. In the following description of the seventh embodiment, the second recess 13 of the coil component 101 according to the seventh embodiment illustrated in FIG. 12 will be mainly described and the features common to the sixth embodiment are not described.

FIG. 12 illustrates a cross-section of the coil component 101 according to the seventh embodiment that is cut in the plane which is parallel to the LT plane and which passes through the coil axis Ax. As illustrated in FIG. 12, in the coil component 101 according to the seventh embodiment, the first recess 11, which is recessed toward the inside of the base body 10, is formed on the first surface 10a of the base body 10, and the second recess 13, which is recessed toward the inside of the base body 10, is formed on the second surface 10b of the base body 10.

In one mode of the present technology, the second recess 13 is formed on the sixth region 10b3 of the second surface 10b of the base body 10. The second recess 13 may be formed in a shape and position symmetrical to the first recess 11 with respect to a plane passing through the center of the coil component 101 in the T-axis direction and extending parallel to a LW plane. The depth of the second recess 13 may be defined in a way similar to that of the depth of the first recess 11.

According to the seventh embodiment, since the sixth region 10b3 is rougher than the other regions of the second surface 10b and the second recess 13 is provided on the sixth region 10b3, the area of contact between the mounting surface 101b of the coil component 101 and another component can be reduced. Hence, undesired adhesion between the coil component 101 and another component can be further reduced. Moreover, the mounting surface 101b is far less likely to be charged when the coil component 101 comes into contact with another component.

### 8. Combinations of Embodiments

Any combination of the embodiments described in this specification is also included in the embodiments disclosed by this specification. The first to seventh embodiments can be combined in various pairs that can be understood by those skilled in the art in reference to the description of the specification. For example, the second embodiment may be combined with the third embodiment, so that the coil component 1 according to the third embodiment can be sealed with the resin molding 40. The second embodiment can be combined with any of the fifth to seventh embodiments.

As will be readily understood by those skilled in the art from the description in this specification, it is also possible to combine three or more embodiments. For example, the second embodiment, the third embodiment, and the sixth embodiment can be combined. By the second embodiment, the third embodiment, and the sixth embodiment being combined, the first external electrode 121 is provided such that the lower surface thereof is flush with the first surface 10a of the base body 10 and the upper surface thereof is flush with the second surface 10b of the base body 10, and the second external electrode 122 is provided such that the lower surface thereof is flush with the first surface 10a of the base body 10 and the upper surface thereof is flush with the second surface 10b of the base body 10 to configure the coil component 101. The coil component 101 configured in this way can be covered with the resin molding 40.

Possible combinations between the embodiments are not limited to those described herein.

### 9. First Manufacturing Method

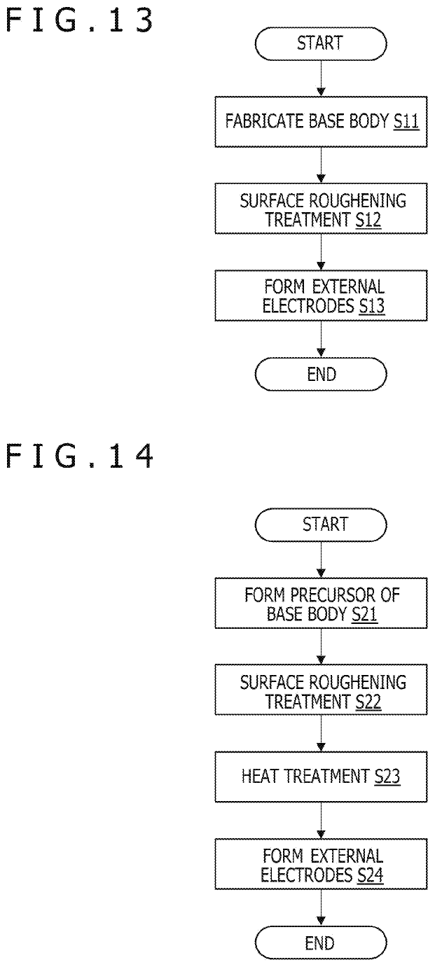

An example of a method of manufacturing the coil component 1 will be described below with reference to FIG. 13. In step S11, the base body 10 in which the coil conductor 25 is embedded is fabricated. The base body 10 can be fabricated by, for example, a sheet lamination method. In the following example, a method of manufacturing the base body 10 by the sheet lamination method will be described.

First, a sheet-shaped sheet member including an insulating material is prepared. The insulating material may be a magnetic material. The sheet member is obtained by, for example, applying a metal magnetic paste to a surface of a plastic base film, drying the metal magnetic paste, and cutting the dried metal magnetic paste in a predetermined size. The metal magnetic paste is prepared by, for example, adding an appropriate amount of solvent to a resin material containing metal magnetic powder. The metal magnetic powder contains a soft magnetic metal material containing Fe. Examples of the material of the metal magnetic powder include metal materials such as Fe and Ni and alloy materials such as Fe—Ni, Fe—Co, Fe—Si, Fe—Si—Al, and Fe—Si—Cr—B. The metal magnetic powder may be a powder mixture obtained by blending different types of metal magnetic powders. An insulating film may be formed on a surface of the metal magnetic powder in advance. A known resin material such as a polyvinyl butyral (PVB) resin, epoxy resin, or silicone resin may be used as the resin material for the metal magnetic paste. The sheet member including a magnetic material will be referred to as a magnetic sheet.

Next, a through-hole is formed at a predetermined position in each of a plurality of magnetic sheets to form a via. Then, screen printing or the like is performed to apply a conductive paste to a surface of each of the plurality of magnetic sheets in which through-holes have been formed, so that a precursor of a conductor pattern is formed on each of the magnetic sheets. The conductive paste contains a conductive material with excellent conductivity such as Ag, Pd, Cu, Ni, Al, or an alloy of these elements. The conductive paste may also contain an Ni—Cu alloy and/or an Ni—Cr alloy. The precursor of the conductor pattern formed on each magnetic sheet has a shape corresponding to one of the conductor patterns C11 to C16. When the conductive paste is applied to the magnetic sheets, the through-holes of the magnetic sheets are filled with the conductive paste, and the conductive paste filling the through-holes forms precursors of vias. Parts of the precursors of the vias form the lead-out portions 25B and 25C after heat treatment.

Next, a mother laminate is formed by stacking the magnetic sheets, on which the precursors of the conductor patterns and via prepared as described above are formed, and the magnetic sheets, on which no precursors of the conductor patterns are formed and which are to be the upper and lower cover layers, and bonding these stacked sheets by thermo-compression bonding. The magnetic sheets on which the precursors of the conductor patterns are formed are stacked on one another such that each of the precursors of the conductor patterns formed on the respective magnetic sheets is connected to adjacent precursors of the conductor patterns through the precursors of the vias. Next, the mother laminate is diced by a cutter such as a dicing machine or a laser processing machine to obtain a chip-shaped molded body. When the coil component 1 is fabricated by the sheet lamination method, the chip-shaped molded body is a laminate having a plurality of sheets stacked one on another. When the coil component 1 is fabricated by a method, e.g., compression molding, other than the sheet lamination method, the resulting chip-shaped molded body does not have a laminated structure.

Next, the chip-shaped molded body is degreased, and the degreased molded body is subjected to heat treatment. The heat treatment is performed on the chip-shaped molded body at a temperature of 400° C. to 950° C. for a duration of 20 to 120 minutes, for example. The heat treatment may be performed in air or in a low-oxygen atmosphere.

The heat treatment sinters the precursors of the conductor patterns and the precursors of the vias, thereby forming the coil conductor 25. Through the heat treatment, the resin and solvent disappear from the magnetic sheets, and the metal magnetic powder contained in the magnetic sheets is sintered. Accordingly, the base body 10 including the coil conductor embedded inside is formed.

Next, in step S12, part of the first surface 10a of the base body 10 fabricated in step S11 is roughened to form the third region 10a3. The region of the first surface 10a of the base body 10 that is roughened in step S12 is the third region 10a3. The regions of the first surface 10a other than the third region 10a3 are not roughened and are thus smoother than the third region 10a3. A region of the first surface 10a between the third region 10a3 and the first end surface 10c is the first region 10a1 and a region of the first surface 10a between the third region 10a3 and the second end surface 10d is the second region 10a2. The first surface 10a can be roughened by sandblasting, laser irradiation, or any other known surface roughening treatments.

Next, in step S13, the first external electrode 21 is formed on the first region 10a1 of the first surface 10a of the base body 10, and the second external electrode 22 is formed on the second region 10a2 of the first surface 10a of the base body 10. The first external electrode 21 is, for example, formed by forming a base electrode layer and then forming a plating layer on a surface of this base electrode. The base electrode layer is formed by applying a conductive paste to part of the first region 10a1 of the first surface 10a. The second external electrode 22 is, for example, formed by forming a base electrode layer and then forming a plating layer on a surface of this base electrode. The base electrode layer is formed by applying a conductive paste to part of the second region 10a2 of the first surface 10a. The plating layer is formed by electrolytic plating or electroless plating.

When the coil component 1 has the first recess 11, the first recess 11 may be formed by grinding the surface (the surface corresponding to the first surface 10a of the base body 10) of the molded body available before or after dicing, at the step of forming the molded body (e.g., step S11 of FIG. 13). Alternatively, the first recess 11 may be formed by roughening the surface until the surface is recessed, at the step of performing the surface roughening treatment (e.g., step S12 of FIG. 13). The first recess 11 may be formed after the third region 10a3 is formed in step S12 or after the first external electrode 21 and the second external electrode 22 are formed in step S13.

In this way, the coil component 1 is fabricated according to the flow illustrated in FIG. 13.

### 10. Second Manufacturing Method

Another example of the method of manufacturing the coil component 1 will be described below with reference to FIG. 14. The manufacturing method illustrated in FIG. 14 is different from the manufacturing method illustrated in FIG. 13 in that the surface roughening treatment is performed in parallel with the fabrication of the base body 10.

In the manufacturing method illustrated in FIG. 14, a chip-shaped molded body is formed as the precursor of the base body 10 in step S21. This molded body can be formed by a method similar to the method described in step S11 above. Specifically, the molded body that is the precursor of the base body 10 may be formed by stacking a plurality of magnetic sheets. The molded body may be formed by a method, e.g., compression molding, other than the lamination method.

Next, in step S22, a surface corresponding to the first surface 10a of the molded body that is the precursor of the base body 10 formed in step S21 is roughened.

The molded body formed in step S22 is subjected to heat treatment in step S23. Specifically, in step S23, the partly roughened molded body is degreased, and the degreased chip-shaped molded body is subjected to heat treatment. The heat treatment is performed on the chip-shaped molded body at a temperature of 400° C. to 950° C. for a duration of 20 to 120 minutes, for example. The heat treatment may be performed in air or in a low-oxygen atmosphere.

Next, in step S24, the first external electrode 21 is formed on the first region 10a1 of the first surface 10a of the base body 10, and the second external electrode 22 is formed on the second region 10a2 of the first surface 10a of the base body 10. In step S24, the first external electrode 21 and the second external electrode 22 can respectively be formed on the first region 10a1 and the second region 10a2 in a similar manner to the one described in step S13 above.

In this way, the coil component 1 is fabricated according to the flow illustrated in FIG. 14.

### 11. Third Manufacturing Method

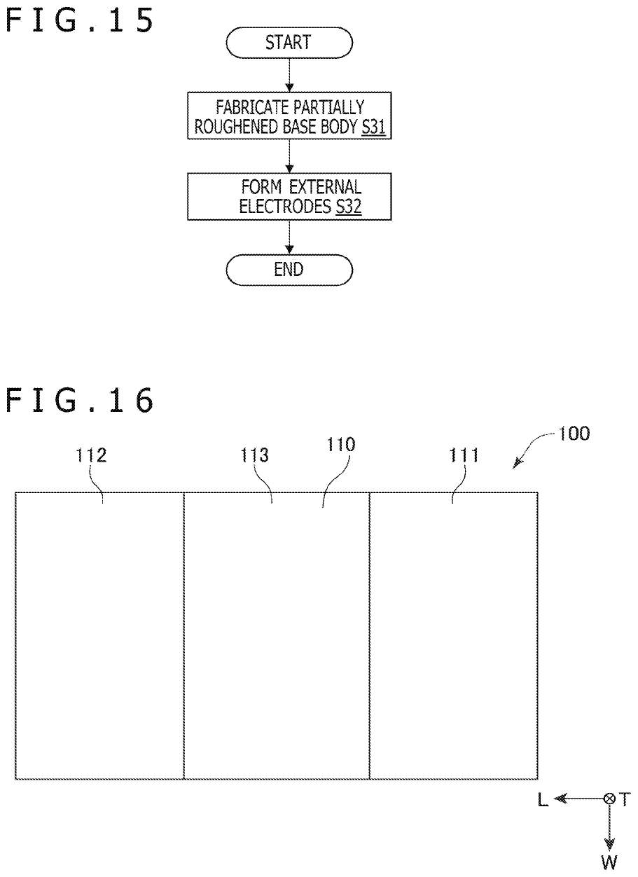

Another example of the method of manufacturing the coil component 1 will be described below with reference to FIG. 15. The manufacturing method illustrated in FIG. 15 is different from the manufacturing method illustrated in FIG. 13 in that a magnetic sheet having a roughened surface corresponding to the third region 10a3 is provided in advance on the lowermost layer of the molded body that is the precursor of the base body 10, to form the third region 10a3, instead of forming the third region 10a3 by performing the surface roughening treatment after the fabrication of the base body 10.

In the manufacturing method illustrated in FIG. 15, the base body 10 in which the coil conductor 25 is embedded and the third region 10a3 is formed on the first surface 10a is fabricated in step S31. Specifically, a plurality of magnetic sheets are prepared as in the manufacturing method illustrated in FIG. 13. Each magnetic sheet contains a plurality of metal magnetic particles. At least one of the plurality of magnetic sheets is a composite magnetic sheet. The composite magnetic sheet is divided into a first portion containing the first metal magnetic particles of a relatively large diameter and a second portion containing the second metal magnetic particles of a smaller diameter than that of the first metal magnetic particles.

Next, a mother laminate is formed by stacking the magnetic sheets, on which the precursors of the conductor patterns and vias prepared as described above are formed, and the magnetic sheets, on which no precursors of the conductor patterns are formed and which are to be the upper and lower cover layers, and bonding these stacked sheets by thermo-compression bonding. When the mother laminate is formed, a composite magnetic sheet, which is divided into a portion containing the first metal magnetic particles and a portion containing the second metal magnetic particles, is provided on the lowermost layer. Next, the mother laminate is diced by a cutter such as a dicing machine or a laser processing machine to obtain a chip-shaped molded body.

The chip-shaped molded body will be described below with reference to FIG. 16. FIG. 16 is a bottom view schematically illustrating a chip-shaped molded body 100. As described above, the composite magnetic sheet is provided on the lowermost layer of the mother laminate. Hence, in the chip-shaped molded body 100 as well, a cut piece of the composite magnetic sheet is also provided on a bottom surface of the chip-shaped molded body 100. As illustrated in FIG. 16, a cut piece of a composite magnetic sheet 110 in the chip-shaped molded body 100 is divided into a first region 111, a second region 112, and a third region 113. The third region 113 of the composite magnetic sheet 110 contains the first metal magnetic particles of a relatively large diameter, and the first region 111 and the second region 112 of the composite magnetic sheet 110 contain the second metal magnetic particles of a smaller diameter than that of the first metal magnetic particles.

Next, the chip-shaped molded body is degreased, and the degreased chip-shaped molded body is subjected to heat treatment. The heat treatment sinters the precursors of the conductor patterns and the precursors of the vias, thereby forming the coil conductor 25. Through the heat treatment, the resin and solvent disappear from the magnetic sheets, and the metal magnetic powder contained in the magnetic sheets is sintered. Accordingly, the base body 10 including the coil conductor 25 embedded inside is formed. In the above-described molded body 100, the composite magnetic sheet 110 is provided on the lowermost layer, so that the first region 111, the second region 112, and the third region 113 of the composite magnetic sheet 110 respectively become the first region 10a1, the second region 10a2, and the third region 10a3 of the base body 10 after the heat treatment.

In the base body 10 fabricated in this way, since the third region 10a3 of the first surface 10a contains the first metal magnetic particles of a large diameter and the first region 10a1 and the second region 10a2 contain the second metal magnetic particles of a small diameter, the irregularities of the third region 10a3 are larger than the irregularities of the first region 10a1 and the second region 10a2. Thus, the third region 10a3, which is rougher than the first region 10a1 and the second region 10a2, is formed.

Next, in step S32, the first external electrode 21 is formed on the first region 10a1 of the first surface 10a of the base body 10, and the second external electrode 22 is formed on the second region 10a2 of the first surface 10a of the base body 10. In step S32, the first external electrode 21 and the second external electrode 22 can respectively be formed on the first region 10a1 and the second region 10a2 by a method similar to the one described in step S13 above.

In this way, the coil component 1 is fabricated according to the flow illustrated in FIG. 15.

An example of the method of manufacturing the coil component 1 by the sheet lamination method has been described above. As will be apparent to those skilled in the art, the coil component 1 may also be fabricated by a compression molding method, a thin film processing method, a slurry build method, or any other known methods.

Some of the steps included in the above-described manufacturing methods may be skipped as necessary. In the method of manufacturing the coil component 1, steps not described explicitly herein may be performed as necessary. Some of the steps included in the method of manufacturing the coil component 1 may be performed in a different order within the purport of the present technology. Some of the steps included in the method of manufacturing the coil component 1 may be performed at the same time or in parallel, if possible.

As will be apparent to those skilled in the art, the coil component 101 can be manufactured by a manufacturing method similar to that of the coil component 1.

### 12. Notes

The dimensions, materials, and arrangements of the constituent elements described for the above-described various embodiments are not limited to those explicitly described for the embodiments, and these constituent elements can be modified to have any dimensions, materials, and arrangements within the scope of the present technology.

Moreover, constituent elements not explicitly described in this specification can be added to the above-described embodiments, and some of the constituent elements described for the embodiments can be omitted.

The terms “first,” “second,” and “third” used in this specification are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

### 13. Supplementary Notes

The embodiments disclosed herein also include the following matters.

### Supplement 1

A coil component including:
a base body having a first surface and including an insulating material, the first surface having a first region, a second region, and a third region provided between the first region and the second region and rougher than the first region and the second region;
a coil conductor provided in the base body;
a first external electrode connected to one end of the coil conductor and provided on the base body in the first region; and
a second external electrode connected to another end of the coil conductor and provided on the base body in the second region.

### Supplement 2

The coil component according to [Supplement 1], in which the third region has a first recess.

### Supplement 3

The coil component according to [Supplement 1] or [Supplement 2], in which a thickness of the first external electrode and a thickness of the second external electrode are smaller than a depth of the first recess.

### Supplement 4

The coil component according to any one of [Supplement 1] through [Supplement 3],
in which the first external electrode is provided in such a manner as to be flush with the first surface of the base body, and
the second external electrode is provided in such a manner as to be flush with the first surface of the base body.

### Supplement 5

The coil component according to any one of [Supplement 1] through [Supplement 4],
in which the base body has a second surface opposite the first surface, and
the second surface has a fourth region, a fifth region, and a sixth region provided between the fourth region and the fifth region and rougher than the fourth region and the fifth region.

### Supplement 6

The coil component according to [Supplement 5],
in which the first external electrode is in contact with the base body on the first surface and the second surface, and
the second external electrode is in contact with the base body on the first surface and the second surface.

### Supplement 7

The coil component according to [Supplement 5] or [Supplement 6], in which the sixth region has a second recess.

### Supplement 8

The coil component according to any one of [Supplement 1] through [Supplement 7],
in which the base body has a second surface opposite the first surface, a third surface connecting the first surface and the second surface to each other, a fourth surface opposite the third surface, a fifth surface connecting the third surface and the fourth surface to each other, and a sixth surface opposite the fifth surface, and
both the first external electrode and the second external electrode are separated from the second surface, the third surface, the fourth surface, the fifth surface, and the sixth surface.

### Supplement 9

The coil component according to any one of [Supplement 1] through [Supplement 8], in which the first region is in contact with one end of the third region, and the second region is in contact with another end of the third region.

### Supplement 10

A circuit module including:
the coil component according to any one of [Supplement 1] through [Supplement 9]; and
a resin molding that seals the coil component.

### Supplement 11

The circuit module according to [Supplement 10],
in which part of the first region is interposed between the first external electrode and the third region, and
part of the second region is interposed between the second external electrode and the third region.

### Supplement 12

An electronic component including:
the circuit module according to [Supplement 10] or [Supplement 11].

### Supplement 13

A method of manufacturing a coil component, including:
fabricating a base body including a coil conductor in its inside and having a first surface;
roughening part of the first surface of the base body such that the first surface has a first region, a second region, and a third region provided between the first region and the second region and rougher than the first region and the second region;
forming a first external electrode in such a manner as to cover at least part of the first region; and
forming a second external electrode in such a manner as to cover at least part of the second region.

### Supplement 14

A method of manufacturing a coil component, including:
fabricating a base body including a coil conductor in its inside and having a first surface including a first region, a second region, and a third region provided between the first region and the second region and rougher than the first region and the second region;
forming a first external electrode in such a manner as to cover at least part of the first region; and
forming a second external electrode in such a manner as to cover at least part of the second region.

What is claimed is:

1. A coil component comprising:
a base body having a first surface and including an insulating material, the first surface having a first region, a second region, and a third region provided between the first region and the second region and rougher than the first region and the second region;
a coil conductor provided in the base body;
a first external electrode connected to one end of the coil conductor and provided on the base body in the first region; and
a second external electrode connected to another end of the coil conductor and provided on the base body in the second region.

2. The coil component according to claim 1, wherein the third region has a first recess.

3. The coil component according to claim 2, wherein a thickness of the first external electrode and a thickness of the second external electrode are smaller than a depth of the first recess.

4. The coil component according to claim 1,
wherein the first external electrode is provided in such a manner as to be flush with the first surface of the base body, and
the second external electrode is provided in such a manner as to be flush with the first surface of the base body.

5. The coil component according to claim 1,
wherein the base body has a second surface opposite the first surface, and
the second surface has a fourth region, a fifth region, and a sixth region provided between the fourth region and the fifth region and rougher than the fourth region and the fifth region.

6. The coil component according to claim 5,
wherein the first external electrode is in contact with the base body on the first surface and the second surface, and
the second external electrode is in contact with the base body on the first surface and the second surface.

7. The coil component according to claim 5, wherein the sixth region has a second recess.

8. The coil component according to claim 1,
wherein the base body has a second surface opposite the first surface, a third surface connecting the first surface and the second surface to each other, a fourth surface opposite the third surface, a fifth surface connecting the third surface and the fourth surface to each other, and a sixth surface opposite the fifth surface, and
both the first external electrode and the second external electrode are separated from the second surface, the third surface, the fourth surface, the fifth surface, and the sixth surface.

9. The coil component according to claim 1, wherein the first region is in contact with one end of the third region, and the second region is in contact with another end of the third region.
